(19) United States
(12) Patent Application Publication
(10) Pub. No.: US 2026/0302948 A1
(43) Pub. Date: Oct. 1, 2026

(54) Controller and control method of multi-phase power converter

(71) Applicant: uPI semiconductor corp., Zhubei City (TW)

(72) Inventors: Yu-Lun HSU, Zhubei City (TW); Chun-Ming LU, Zhubei City (TW)

(21) Appl. No.: 19/567,452

(22) Filed: Mar. 16, 2026

(30) Foreign Application Priority Data
Mar. 25, 2025 (CN) 202510363695.8

(51) Int. Cl. H02M 3/158; H02M 1/00

(52) U.S. Cl. CPC H02M 3/158; H02M 1/0009; H02M 1/0016

(57) ABSTRACT

A controller of a multi-phase power converter is disclosed. The multi-phase power converter includes first and second output stages for generating first-phase and second-phase output currents respectively. The controller includes a current sensing circuit and a current balancing control circuit. The current sensing circuit is coupled to the first output stage and the second output stage for sensing the first-phase output current and the second-phase output current to generate a first current sensing signal and a second current sensing signal. The current balancing control circuit is coupled to the current sensing circuit for receiving the first current sensing signal and the second current sensing signal. The current balancing control circuit further includes a delay unit for enabling the current balancing control circuit only after a delay period following by the second output stage response a phase-rising signal to generate the second-phase output current.

### BACKGROUND OF THE INVENTION

### 1. Field of the Invention

The invention relates to a power converter; in particular, to a controller and a control method of a multi-phase power converter.

### 2. Description of the Prior Art

When the number of operating phases of a DC-DC power converter is greater than or equal to two, such as a three-phase (the phases PH1 to PH3) operation shown in FIG. 1, a current balancing control circuit is required to balance output currents of the phases to prevent excessive output current in a single phase, which could lead to heat accumulation and component burnout.

For example, as shown in FIG. 2, when the DC-DC power converter is operating in a two-phase mode, a first current sensor CS1 and a second current sensor CS2 may sense a first-phase current ISEN1 and a second-phase current ISEN2 respectively. These sensed currents are then replicated by a first current mirror CM1 and a second current mirror CM2 to a current balancing control circuit CB to balance the output currents of the phases.

During a phase-rising process (i.e., increasing the number of the operating phases) of a DC-DC power converter, assuming the number of the operating phases increases from one to four, since the newly added three phases (the second phase to the fourth phase) are initially without output current and in a current-free state, a significant current difference may occur between the first phase already having output current and the newly added second phase to fourth phase. Therefore, the current balancing control circuit CB should increase the on-times of the second phase to the fourth phase and reduce the on-time of the first phase correspondingly.

However, since the on-time of the first phase can only be reduced to a minimum possible duration, while the on-times of the second phase to the fourth phase can continue to increase, the increased on-time of the second phase to the fourth phase may exceed the reduced on-time of the first phase. This results in an average current exceeding a load current for a short period, and as shown in a dashed box of FIG. 3, the output voltage VOUT of the DC-DC power converter exhibits an overshoot phenomenon, which requires to be further resolved.

### SUMMARY OF THE INVENTION

Therefore, the invention provides a controller and a control method of a multi-phase power converter to solve the above-mentioned problems of the prior arts.

An embodiment of the invention is a controller of a multi-phase power converter. In this embodiment, the multi-phase power converter includes a first output stage and a second output stage for generating a first-phase output current and a second-phase output current respectively. The controller includes a current sensing circuit and a current balancing control circuit. The current sensing circuit is coupled to the first output stage and the second output stage and used for sensing the first-phase output current and the second-phase output current to generate a first current sensing signal and a second current sensing signal. The current balancing control circuit is coupled to the current sensing circuit and used for receiving the first current sensing signal and the second current sensing signal. The current balancing control circuit further includes a delay unit. The delay unit is used for enabling the current balancing control circuit only after a delay period following by the second output stage response a phase-rising signal to generate the second-phase output current.

Another embodiment of the invention is a control method of a multi-phase power converter. In this embodiment, the multi-phase power converter includes a first output stage and a second output stage for generating a first-phase output current and a second-phase output current respectively. The control method includes the following steps: (a) sensing the first-phase output current and the second-phase output current to generate a first current sensing signal and a second current sensing signal; (b) when the second output stage begins to generate the second-phase output current in response to a phase-rising signal, enabling the current balancing control circuit after waiting for a delay period; and (c) the current balancing control circuit generating a first adjustment signal and a second adjustment signal according to the first current sensing signal and the second current sensing signal.

Compared to the prior art, the controller and the control method of the multi-phase power converter proposed in this invention may adaptively adjust off-time of each phase during the phase-rising process of the multi-phase power converter to ensure that on-time of each phase is the same, so that the average current does not exceed the load current. Therefore, it may effectively avoid the overshoot or undershoot phenomena in the output voltage of the multi-phase power converter.

The advantage and spirit of the invention may be understood by the following detailed descriptions together with the appended drawings.

### BRIEF DESCRIPTION OF THE APPENDED DRAWINGS

The accompanying drawings of the invention are described as follows:

FIG. 1 is a schematic diagram of a conventional three-phase DC-DC power converter.

FIG. 2 is a schematic diagram of the current balance control for a conventional two-phase DC-DC power converter.

FIG. 3 is a waveform diagram of the overshoot phenomenon of the output voltage of a conventional DC-DC power converter during a phase-rising process.

FIG. 4 is a schematic diagram of a controller of a multi-phase power converter in an embodiment of the invention.

FIG. 5A is a schematic diagram of an embodiment of a delay unit.

FIG. 5B is a schematic diagram showing that an adaptive switching circuit generates a switching signal by using a comparator to compare node voltages of two nodes and operating a NOT gate.

FIG. 6 illustrates a waveform diagram showing how the overshoot of output voltage during the phase-rising process of the DC-DC power converter in the prior art is effectively improved in the invention.

FIG. 7 illustrates a flowchart of a control method of a multi-phase power converter in another embodiment of the invention.

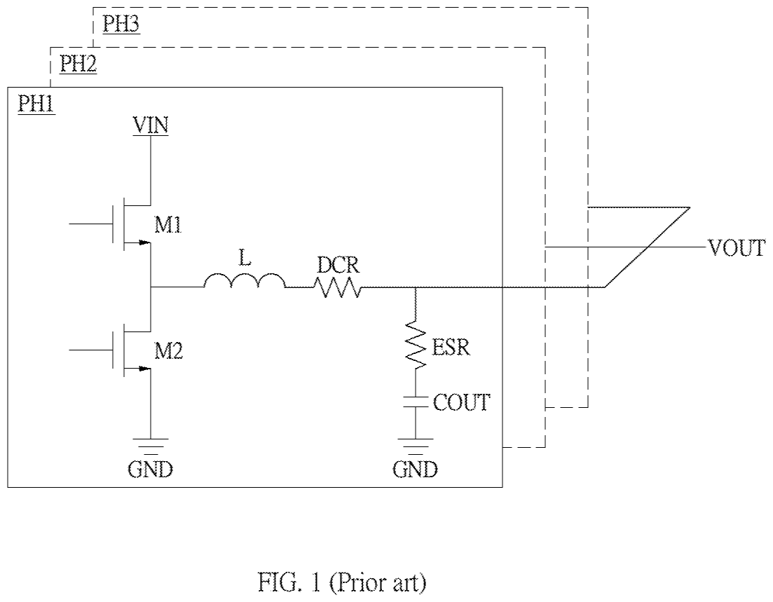

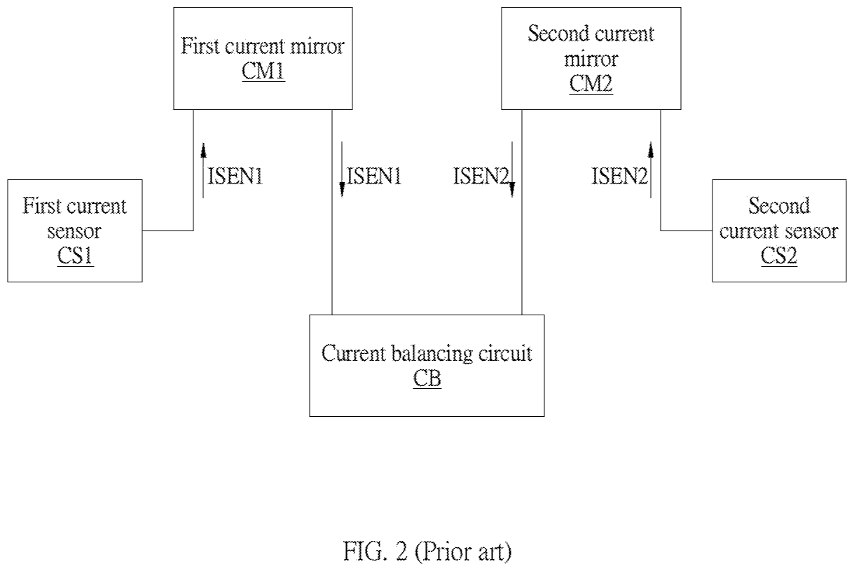

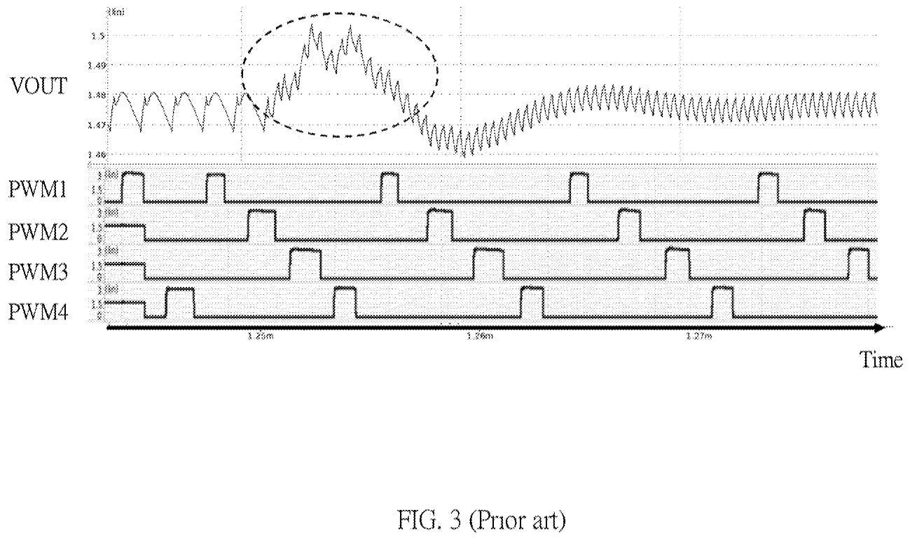

### DETAILED DESCRIPTION OF THE INVENTION

Exemplary embodiments of the invention are referenced in detail now, and examples of the exemplary embodiments are illustrated in the drawings. Further, the same or similar reference numerals of the components/components in the drawings and the detailed description of the invention are used on behalf of the same or similar parts.

A specific embodiment of the invention is a controller of a multi-phase power converter. In this embodiment, the number of operating phases of the multi-phase power converter is greater than or equal to two, and the output current of the multi-phase power converter is equal to the sum of the output currents of the operating phases.

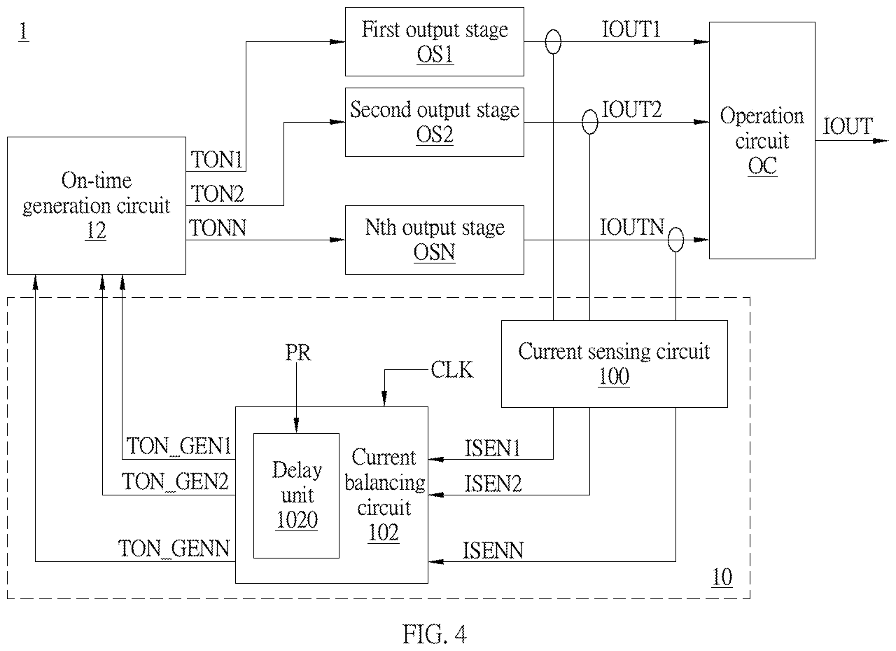

Please refer to FIG. 4. FIG. 4 illustrates a schematic diagram of a controller of a multi-phase power converter in this embodiment. As shown in FIG. 4, the multi-phase power converter 1 is an N-phase power converter with N operating phases, wherein N is a positive integer greater than or equal to 2. The multi-phase power converter 1 includes a controller 10, an on-time generation circuit 12 and N output stages OS1~OSN corresponding to the N operating phases respectively. The controller 10 is coupled to output terminals of the N output stages OS1~OSN and the on-time generation circuit 12 respectively. The on-time generation circuit 12 is coupled to input terminals of the N output stages OS1~OSN and the controller 10 respectively.

The N output stages OS1~OSN include a first output stage OS1 corresponding to a first phase of the N phases, a second output stage OS2 corresponding to a second phase of the N phases, . . . , an Nth output stage OSN corresponding to an Nth phase of the N phases. The first output stage OS1, the second output stage OS2, . . . , and the Nth output stage OSN are used to generate a first phase output current IOUT1, a second phase output current IOUT2, . . . , an Nth phase output current IOUTN respectively. An output current IOUT of the multi-phase power converter 1 is equal to a sum of the first phase output current IOUT1, the second phase output current IOUT2, . . . , and the Nth phase output current IOUTN. In an embodiment, the multi-phase power converter 1 may receive the first phase output current IOUT1 from the first output stage OS1 to the Nth phase output current IOUTN from the Nth output stage OSN through an operational circuit OC, and the operational circuit OC performs summation calculation to generate the output current IOUT, but not limited to this.

The controller 10 of the multi-phase power converter 1 includes a current sensing circuit 100 and a current balancing control circuit 102. The current sensing circuit 100 is coupled to the output terminals of the first output stage OS1, the second output stage OS2, . . . , and the Nth output stage OSN, and the current balancing control circuit 102 and used to respectively sense the first phase output current IOUT1, the second phase output current IOUT2, . . . , and the Nth phase output current IOUTN and respectively generate a first current sensing signal ISEN1, a second current sensing signal ISEN2, . . . , and the Nth current sensing signal ISENN to the current balancing control circuit 102.

The current balancing control circuit 102 is coupled to the current sensing circuit 100 and the on-time generation circuit 12 respectively. The current balancing control circuit 102 receives the first current sensing signal ISEN1, the second current sensing signal ISEN2, . . . , and the Nth current sensing signal ISENN and generates a first adjustment signal TON_GEN1, a second adjustment signal TON_GEN2, . . . , and an Nth adjustment signal TON_GENN according to the first current sensing signal ISEN1, the second current sensing signal ISEN2, . . . , and the Nth current sensing signal ISENN, and transmits the first adjustment signal TON_GEN1, the second adjustment signal TON_GEN2, . . . , and the Nth adjustment signal TON_GENN to the on-time generation circuit 12.

The on-time generation circuit 12 generates a first control signal TON1 to an Nth control signal TONN according to the first adjustment signal TON_GEN1 to the Nth adjustment signal TON_GENN, and transmits the first control signal TON1 to the Nth control signal TONN to the first output stage OS1 to the Nth output stage OSN. The first control signal TON1 to the Nth control signal TONN include the on-times of the first phase to the Nth phase respectively, thereby controlling the on-state or off-state of the switches in the first output stage OS1 to the Nth output stage OSN and the output currents of the first phase IOUT1 to the Nth phase IOUTN respectively.

It should be noted that the current balancing control circuit 102 includes a delay unit 1020. It is assumed that the number of operating phases of the multi-phase power converter 1 increases from original single-phase (i.e., the first phase) to N-phase (i.e., the first phase to the Nth phase), that is, the multi-phase power converter 1 originally only had the first output stage OS1 corresponding to the first phase generating the first phase output current IOUT1, which will become the first output stage OS1 corresponding to the first phase generating the first phase output current IOUT1 to the Nth output stage OSN corresponding to the Nth phase generating the Nth phase output current IOUTN respectively.

In other words, the second output stage OS2 to the Nth output stage OSN, which originally did not generate output currents, will begin to generate the second phase output current IOUT2 to the Nth phase output current IOUTN respectively in response to a phase-rising signal PR. After a delay period begins when the second output stage OS2 to the Nth output stage OSN generate the second phase output current IOUT2 to the Nth phase output current IOUTN, the delay unit 1020 will enable the current balancing control circuit 102. It also delays the current balancing control circuit 102 to generate the second adjustment signal TON_GEN2 to the Nth adjustment signal TON_GENN to the on-time generation circuit 12 according to the second current sensing signal ISEN2 to the Nth current sensing signal ISENN. It also further delays the time that the on-time generation circuit 12 to begin to shorten the on-time of the second phase to the Nth phase according to the second adjustment signal TON_GEN2 to the Nth adjustment signal TON_GENN.

In practical applications, this delay period may be generated according to a clock signal CLK received by the current balancing control circuit 102 from the system, or determined according to the first current sensing signal ISEN1 to the Nth current sensing signal ISENN, but not limited to this.

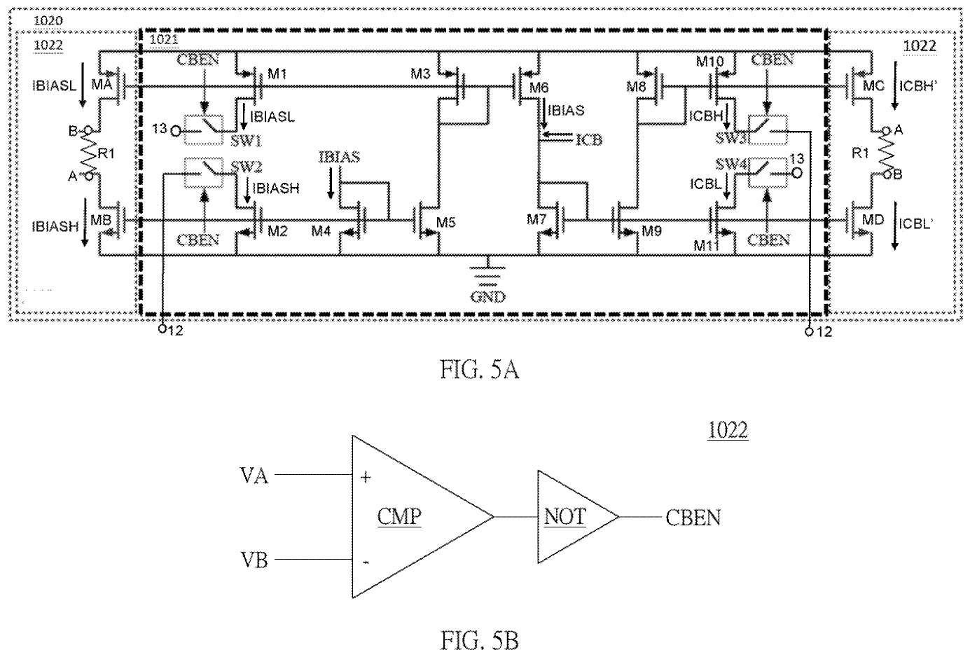

Please refer to FIG. 5A. FIG. 5A illustrates a schematic diagram of an embodiment of the delay unit 1020. As shown in FIG. 5A, the delay unit 1020 includes a current balancing circuit 1021 and an adaptive switching circuit 1022. The adaptive switching circuit 1022 is disposed on two sides of the current balancing circuit 1021. The current balancing circuit 1021 includes transistors M1 to M11 and switches SW1 to SW4. The adaptive switching circuit 1022 includes transistors MA to MD and resistors R1.

The transistors M1, M3, M6, M8 and M10 in the current balancing circuit 1021 and the transistors MA and MC in the adaptive switching circuit 1022 are connected to each other via a common source. The transistors M2, M4, M5, M7, M9 and M11 in the current balancing circuit 1021 and the transistors MB and MD in the adaptive switching circuit 1022 are connected to each other via the common source and coupled to a ground terminal. A drain of the transistor M3 is coupled to a source of the transistor M5. A drain of the transistor M6 is coupled to a drain of the transistor M7, and a current difference ICB between the current signals ICBH and ICBL flows from the transistor M6 to the transistor M7. A source and a gate of the transistor M4 are coupled to a gate of the transistor M5 and both coupled to a current source IBIAS.

The switch SW1 is coupled between a drain of the transistor M1 and the on-time generation circuit 12. The current signal ICBL flows from the transistor M1 to the switch SW1. The switch SW2 is coupled between a source of the transistor M2 and the on-time generation circuit 12. The current signal ICBH flows from the switch SW2 to the transistor M2. The switch SW3 is coupled between a drain of the transistor M10 and the on-time generation circuit 12. The current signal ICBH flows from the transistor M10 to the switch SW3. The switch SW4 is coupled between a source of the transistor M11 and the on-time generation circuit 12. The current signal ICBL flows from the switch SW4 to the transistor M11.

The on-state/off-state of the switches SW1 to SW4 is controlled by a switch switching signal CBEN. When the switch switching signal CBEN is high-level, it controls the switches SW1 to SW4 to be switched on. When the switch switching signal CBEN is low-level, it controls the switches SW1 to SW4 to be switched off.

The gates of the transistors M1, M3 and M6 in the current balancing circuit 1021 are coupled to the gate of the transistor MA in the adaptive switching circuit 1022. The gates of the transistors M3 and M6 are also coupled between the drains of the transistors M3 and M5. The gates of the transistors M2, M4 and M5 in the current balancing circuit 1021 are coupled to the gate of the transistor MB in the adaptive switching circuit 1022. The gates of the transistors M8 and M10 in the current balancing circuit 1021 are coupled to the gate of the transistor MC in the adaptive switching circuit 1022. The gates of the transistors M8 and M10 are also coupled between the drains of the transistor M8 and M9. The gates of the transistors M9 and M11 in the current balancing circuit 1021 are coupled to the gate of the transistor MD in the adaptive switching circuit 1022. In the adaptive switching circuit 1022, the resistor R1 is coupled between the drains of the transistors MA and MB, and the resistor R1 is coupled between the drains of the transistors MC and MD.

The following is a brief description of one implementation of the current balancing circuit 102. First, the current balancing circuit 1021 receives a current difference ICB formed by a current comparator (not shown) processing the comparison result of the first current sensing circuit ISEN1 and the second current sensing circuit ISEN2 in the current sensing circuit 100. Then, the transistors M2, M5, M3, M6 and M1 replicate the current IBIAS to form currents IBIASL and IBIASH. Next, the transistor M7 mixes the currents IBIAS and the current difference ICB. The transistors M10 and M11 replicate the aforementioned mixed currents to form current signals ICBH and ICBL respectively. In another embodiment, due to process differences, the transistors M10 and M1 are not matched, so values of the current signals ICBH and ICBL will be different, and values of the currents IBIASL and IBIASH will be also different. Subsequently, the adaptive switching circuit 1022 replicates the current signals ICBH and ICBL from the current balancing circuit 1021 to generate replicated current signals ICBH′ and ICBL′.

When the current between the phases reaches equilibrium, that is, the value of the current difference ICB is 0. Because the current value of the current signal ICBH′ of the transistor MC is equal to the current IBIASL, the current signal ICBH′ will flow directly to the transistor MB, and the current ICBL′ of the transistor MA will also flow directly to the transistor MD. At this time, since no current flows through the resistor R1, a voltage difference between the node A and the node B is 0 (that is, a node voltage VA of the node A is equal to a node voltage VB of the node B). After the comparator CMP in FIG. 5B compares the node voltage VA of the node A with the node voltage VB of the node B and the operation of the NOT gate NOT, it will output the switch switching signal CBEN as 1 to switch on the switches SW1 to SW4, which will cause the output terminals of the transistors M1, M2, M10 and M11 to output signals to the terminal 12, that is, to output the current balance signal.

However, if the current between the phases is unbalanced, the value of the current difference ICB is greater than 0. Then, the value ICBH′ of the current signal of the transistor MC will be greater than the value IBIASH of the current signal of transistor MB. The current value (ICBH′ IBIASH) that the transistor MC exceeds will flow from the node A, through the resistor R1 and the node B to the transistor MB. And, the value ICBL′ of the current signal of transistor MA will be greater than the value IBIASL of the current signal of transistor MB. The current value (ICBL′−IBIASL) that the transistor MA exceeds will flow from the node B, through the resistor R1 and the node B to the transistor MD. At this time, the current will flow through the resistor R1, causing the voltage difference between the node A and the node B to be non-zero (i.e., the difference between the node voltage VA of the node A and the node voltage VB of the node B is not equal). Furthermore, through the comparison by the comparator CMP in FIG. 5B and the operation of the NOT gate NOT, the switch switching signal CBEN will be outputted as 0, thus switching off the switches SW1 to SW4. This prevents the output terminals of the transistors M1, M2, M10 and M11 from outputting signals to the terminal 12, i.e., preventing the current balance signal from being outputted.

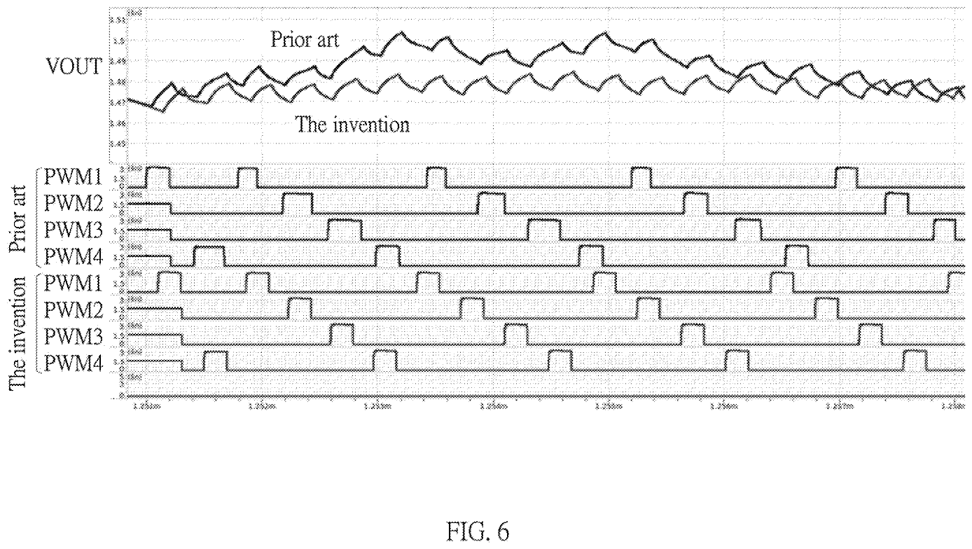

Please refer to FIG. 6. FIG. 6 illustrates a waveform diagram showing how the overshoot of output voltage during the phase-rising process of the DC-DC power converter in the prior art is effectively improved in the invention. As shown in FIG. 6, when the number of the operating phases of the DC-DC power converter increases from one phase to four, the current balancing control circuit in the prior art increases the on-time of the pulse-width modulation signals PWM2 to PWM4 of the second phase to the fourth phase, and correspondingly reduces the on-time of the pulse-width modulation signal PWM1 of the first phase. This results in the on-time of the pulse-width modulation signal PWM2 of the second phase to the pulse-width modulation signal PWM4 of the fourth phase being greater than the on-time of the pulse-width modulation signal PWM1 of the first phase. Consequently, the average current is higher than the load current for a short period of time, causing the overshoot phenomenon of the output voltage VOUT.

Conversely, the current balancing control circuit 102 of the invention may adaptively delay the activation time of the current balance controller, allowing the currents between phases to be balanced (approximate) before activating the current balance controller, thereby improving the overshoot phenomenon of the output voltage caused by the current balance controller.

Another specific embodiment of the invention is a control method of a multi-phase power converter. In this embodiment, the number of operating phases of the multi-phase power converter is greater than or equal to two, and an output current of the multi-phase power converter is equal to a sum of the output currents of the operating phases.

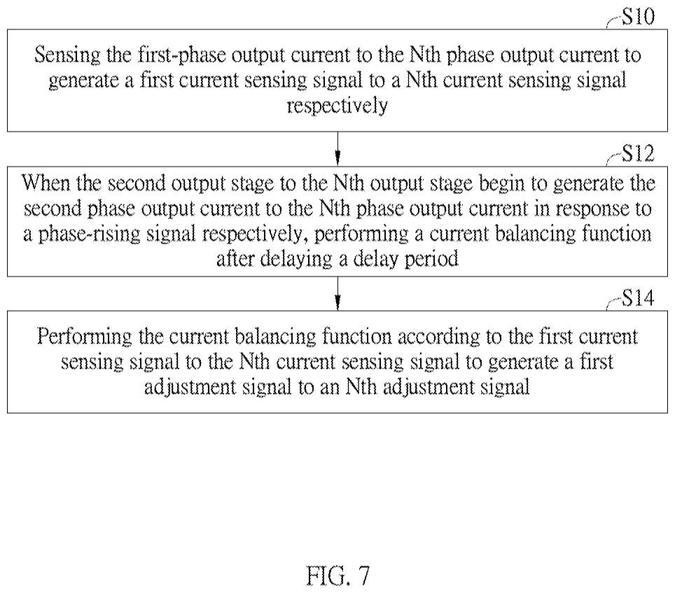

Please refer to FIG. 7, assuming the multi-phase power converter includes a first output stage to an Nth output stage, and the first output stage to the Nth output stage respectively generate a first phase output current to an Nth phase output current, the control method of the multi-phase power converter includes the following steps:

Step S10: sensing the first-phase output current to the Nth phase output current to generate a first current sensing signal to a Nth current sensing signal respectively;

Step S12: when the second output stage to the Nth output stage begin to generate the second phase output current to the Nth phase output current in response to a phase-rising signal respectively, performing a current balancing function after delaying a delay period; and

Step S14: performing the current balancing function according to the first current sensing signal to the Nth current sensing signal to generate a first adjustment signal to an Nth adjustment signal.

In an embodiment, the control method of the multi-phase power converter further includes a step of generating a first on-time and a plurality of second on-times to the first output stage and the second output stage according to the first adjustment signal and the second adjustment signal respectively to control on-times of the switches in the first output stage and the second output stage, but not limited to this.

In another embodiment, the delay period may be determined according to the first current sensing signal and the second current sensing signal, or the delay period may be generated according to a clock signal, without specific limitations.

In summary, the controller and the control method of the multi-phase power converter proposed in this invention may adaptively adjust off-time of each phase during the phase-rising process of the multi-phase power converter to ensure that on-time of each phase is the same, so that the average current does not exceed the load current. Therefore, it may effectively avoid the overshoot or undershoot phenomena in the output voltage of the multi-phase power converter.

With the example and explanations above, the characteristics and spirits of the invention describe well. Those skilled in the art will readily observe that numerous modifications and alterations of the device may realize while retaining the teaching of the invention. Accordingly, the above disclosure construct as limited only by the metes and bounds of the appended claims.

What is claimed is:

1. A controller of a multi-phase power converter comprising a first output stage and a second output stage for generating a first-phase output current and a second-phase output current respectively, the controller comprising:
a current sensing circuit, coupled to the first output stage and the second output stage, for sensing the first-phase output current and the second-phase output current to generate a first current sensing signal and a second current sensing signal; and
a current balancing control circuit, coupled to the current sensing circuit, for receiving the first current sensing signal and the second current sensing signal;
wherein the current balancing control circuit further comprises:
a delay unit, for enabling the current balancing control circuit only after a delay period following by the second output stage response a phase-rising signal to generate the second-phase output current.

2. The controller of claim 1, wherein the multi-phase power converter further comprises N output stages for responding to the phase-rising signal to begin to generate N phase output currents, wherein N is a positive integer greater than 2, the current sensing circuit is coupled to the N output stages and senses the N phase output currents respectively to generate N phase current sensing signals.

3. The controller of claim 1, wherein the delay period relates the first current sensing signal and the second current sensing signal.

4. The controller of claim 1, wherein the current balancing control circuit further generates a first adjustment signal and a second adjustment signal according to the first current sensing signal and the second current sensing signal respectively.

5. The controller of claim 4, wherein the multi-phase power converter further comprises:
an on-time generation circuit, coupled between the current balancing control circuit and the first output stage and the second output stage, for receiving the first adjustment signal and the second adjustment signal and generating a first control signal and a second control signal to the first output stage and the second output stage respectively to control the first-phase output current and the second-phase output current in the first output stage and the second output stage.

6. The controller of claim 1, wherein the delay unit further comprises:
a current balancing circuit comprising a plurality of transistors and a plurality of switches, the plurality of transistors is used for replicating the first-phase output current and the second-phase output current, the plurality of switches is switched on after the current balancing control circuit is enabled, then the plurality of switches transmits the first adjustment signal and the second adjustment signal; and
an adaptive switching circuit electrically connected to the current balancing circuit and used for determining whether to enable the current balancing control circuit according to the first-phase output current and the second-phase output current, the adaptive switching circuit comprises a resistor, two terminals of the resistor are connected to the plurality of transistors;
wherein when a different potential difference across the resistor is caused by the first-phase output current and the second-phase output current flowing through the plurality of transistors, the adaptive switching circuit enables the current balancing control circuit.

7. A control method for a multi-phase power converter, the multi-phase power converter comprising a first output stage and a second output stage for generating a first-phase output current and a second-phase output current respectively, the control method comprising the following steps:
(a) sensing the first-phase output current and the second-phase output current to generate a first current sensing signal and a second current sensing signal;
(b) when the second output stage begins to generate the second-phase output current in response to a phase-rising signal, enabling the current balancing control circuit after waiting for a delay period; and
(c) the current balancing control circuit generating a first adjustment signal and a second adjustment signal according to the first current sensing signal and the second current sensing signal.

8. The control method of claim 7, wherein the delay period relates to the first current sensing signal and the second current sensing signal.

9. The control method of claim 7, wherein the delay period relates to a clock signal.

10. The control method of claim 7, further comprising:
generating a first on-time and a plurality of second on-times to the first output stage and the second output stage according to the first adjustment signal and the second adjustment signal respectively to control on-times of the switches in the first output stage and the second output stage.
